(19) United States
(12) Patent Application Publication
(10) Pub. No.: US 2025/0367718 A1
(43) Pub. Date: Dec. 4, 2025

(54) SYSTEM AND METHOD FOR DECONTAMINATING SOIL USING ELECTROKINETICS

(71) Applicant: 12974533 Canada Inc., Calgary (CA)

(72) Inventors: James Hanna, Pickering (CA); John Vandersleen, Calgary (CA); Aryn Maclean, Dartmouth (CA); Evan Way, Hamilton (CA)

(21) Appl. No.: 18/994,510

(22) PCT Filed: Jul. 13, 2023
(86) PCT No.: PCT/CA2023/050944

§ 371 Date: Jan. 14, 2025

(30) Foreign Application Priority Data
Jul. 13, 2022 (CA) 3167469

(51) Int. Cl. B09C 1/08

(52) U.S. Cl. CPC B09C 1/085

(57) ABSTRACT

An ex situ electrokinetic system and method for decontaminating soils and other fine-textured media, including salt-contaminated soil, is disclosed. The system consists of a series of unit processes that continuously remove inorganic and organic contaminants yielding a final decontaminated product. The initial soil conditioning unit process produces a homogenous slurry saturated with a customised electrolyte. The next unit process uses electroosmosis and electromigration along with hydraulic pressure to move electrolyte and dissolved ions through the slurry. The contaminants are released into the electrolyte and are removed at the cathodes. The last unit process removes residual electrolyte and contaminants producing a final product suitable for land application or other uses.

### PRIORITY CLAIM

This application is a U.S. national phase of International Patent Application No. PCT/CA2023/050944 filed Jul. 13, 2023; which claims the benefit of priority from Canadian Patent Application No. 3167469 filed Jul. 13, 2022, the contents of which are incorporated herein by reference.

### TECHNICAL FIELD

This innovation relates to the field of soil decontamination for pollution control, environmental clean up and reclamation. More particularly, this innovation relates to the decontamination of contaminated, fine-texture soils.

### BACKGROUND

Soil contamination results from a broad spectrum of organic and inorganic contaminants originating from various industrial, commercial, retail and agricultural practices. Many systems and methods exist for removing or destroying contaminants in situ or ex situ. Contaminants that are removed may be treated on or off site or sent for secure disposal. With coarser-texture soils, ex situ washing among other techniques can be used. Alternatively, various in situ decontamination systems have been developed (e.g., chemical oxidation/Fenton process). These techniques are not suitable for fine-texture soils due to the low hydraulic conductivities, large loads of contaminants that are tightly secured in the soil and the risk of capillary action drawing contaminants back to the surface.

Electrokinetics have been used for decontaminating medium to fine-texture soils. Many electrokinetic decontamination systems are in situ. With in situ electrokinetic processes, an electrolyte must first be added to produce a saturated soil that will then pass a current. Achieving full and uniform saturation in situ is difficult. If soil saturation and the soil itself are not uniform, the most common situation, contaminant removal is uneven and unpredictable. Further, large volumes of electrolyte need to be added to remove the contaminants in situ resulting in large volumes of spent electrolyte with relatively dilute contaminant concentrations. This spent electrolyte then needs to be treated or securely disposed, a costly process. Finally, these processes need to be run for an extended time due to the relatively slow movement of electrolyte through medium and fine-grained soils by means of electrokinetics.

### SUMMARY

There is provided in one embodiment, a method and system to decontaminate on-site a variety of soil types. Both organic and inorganic contaminants can be removed, yielding an environmentally acceptable product. This decontaminated soil can then be replaced from where it was excavated. Following decontamination, a site is ready to be safely used for productive activities or for the decontaminated soil to be used for other purposes. Depending on the intended end use of a contaminated site, the decontamination process may be adjusted to meet the final decontamination requirements for future use(s) or for the extracted and decontaminated soil to be suitable for other uses.

In an embodiment, there is disclosed a method of facilitating decontamination of soil through application of an electrical current. An electrolyte is mixed into the soil to form a slurry. The slurry is passed through a flow path in a contiguous series of a decontamination chamber and a dewatering chamber, the flow path extending between an inlet and an outlet, each of the decontamination chamber and the dewatering chamber including at least two electrodes, the flow path passing between the at least two electrodes in the decontamination chamber and the at least two electrodes of the dewatering chamber configured to induce movement of the electrolyte within the slurry.

In various embodiments, there may be included any one or more of the following features of the method: screening of the soil to remove materials above a certain size prior to passing the slurry through the flow path; the at least two electrodes in the dewatering chamber comprise at least one cathode and at least one anode, and passing a DC current through the at least one cathode and at least one anode to induce electrolyte movement within the flow path in the decontamination chamber from the at least one anode to the at least one cathode; the at least two electrodes in the dewatering chamber comprise at least one cathode and at least one anode, and passing a DC current through the at least one cathode and at least one anode to induce electrolyte movement within the flow path from the at least one anode to the at least one cathode; maintaining a vertical hydraulic pressure gradient to induce electrolyte movement within the flow path in the decontamination chamber from the at least one anode to the at least one cathode; maintaining a horizontal hydraulic pressure gradient above atmospheric pressure to induce slurry movement within the flow path in the decontamination chamber and the dewatering chamber from the inlet to the outlet; introducing electrolyte into the decontamination chamber adjacent to the at least one anode at above atmospheric pressure to induce movement of the electrolyte through the flow path to the cathodes of the decontamination chamber; removing electrolyte from the decontamination chamber adjacent to the at least one cathode; having at least two electrodes in the decontamination chamber and in the dewatering chamber that further comprise a plurality of cathodes and a plurality of corresponding anodes together forming corresponding cathode and anode pairs having a DC current passing between them to induce movement of one or both of electrolyte and dissolved ions within the flow path from the plurality of anodes to the plurality of cathodes; having each of the corresponding cathode and anode pairs in the decontamination chamber separated by at least a minimum distance, having the at least two electrodes in the dewatering chamber separated by a second distance and having the minimum distance being larger than the second distance; adjusting an applied power across one or more of the at least two electrodes in each of the decontamination chamber and the dewatering chamber while the slurry passes through the flow path; controlling a flow rate of the slurry through the flow path by means of an adjustable valve on the outlet; collecting the electrolyte at the cathodes to be recycled after exiting the decontamination chamber and the dewatering chamber using a countercurrent flow pattern; collecting some of the electrolyte from the decontamination chamber and the dewatering chamber at the cathodes for refurbishment; refurbishing the collected electrolyte from the decontamination chamber and the dewatering chamber; reusing the refurbished electrolyte in the treatment process; and using one or more control systems to balance a flow of the slurry and a flow of the electrolyte and the electric field strength and the applied pressure.

In an embodiment, there is disclosed a decontamination system for facilitating the decontamination of soil through application of an electrical current. A plurality of treatment units is connected in series, each treatment unit having connected decontamination chambers and dewatering chambers. Each treatment unit has a flow path between an inlet and an outlet. Each decontamination chamber and each dewatering chamber includes at least one anode and cathode pair within the flow path.

In various embodiments, there may be included any one or more of the following features of the decontamination system: a power source which may be a DC generator to supply a DC voltage to the at least one anode and cathode pair; a pressure source to maintain hydraulic pressure above atmospheric pressure to the slurry within the decontamination chamber and the dewatering chamber to induce movement through the flow path to the outlet; a screening unit to filter the soil by removing materials above a certain size prior to introducing the slurry into the decontamination chamber; a control system which is configured to control: the rate at which electrolyte is added to the screened soil to produce a slurry; the rate at which electrolyte is added to the soil prior to entering the decontamination chamber; the applied pressure to the slurry at the inlet to the decontamination chamber; the applied pressure to the electrolyte fed to the anodes; the applied voltage to one or more electrode pairs while the slurry passes through the flow path; the rate of release of soil at the outlet from the dewatering chamber; more than one cathode and anode pairs in series along the flow path; cathode and anode pairs that are separated by a distance along part of the flow path and in which the distance between cathode and anode pairs adjacent to the inlet is larger than the distance between cathode and anode pairs adjacent the outlet; and gas vents adjacent to the at least one cathode and the at least one anode on both of the decontamination chamber and dewatering chamber.

In an embodiment, there is disclosed a treatment unit for facilitating the decontamination of soil through application of an electrical current. The treatment unit includes an inlet and an outlet. A decontamination chamber and a dewatering chamber are adjacent to each other and define a flow path between the inlet and the outlet. At least one anode and cathode pair are within each of the decontamination chamber and the dewatering chamber, the flow path passing between each of the at least one anode and cathode pairs.

In various embodiments, there may be included any one or more of the following features of the treatment unit: the at least one anode and cathode pair further comprises a plurality of anode and cathode pairs adjacent to each other, and the flow path passing between each of the plurality of anode and cathode pairs; the flow path narrows within the dewatering chamber towards the outlet; electrolyte inlets adjacent to an anode of the at least one anode and cathode pairs and electrolyte outlets adjacent to a cathode of the at least one anode and cathode pairs; and a valve at the outlet to control a flow of slurry through the flow path.

In an embodiment, there is disclosed a method of facilitating decontamination of soil through application of hydraulic pressure. An electrolyte is mixed into the soil to form a slurry. The slurry passes through a flow path in a decontamination chamber and a dewatering chamber at a pressure above atmospheric pressure, the flow path extending between an inlet and an outlet, the decontamination chamber including electrolyte inlets and electrolyte outlets, wherein the electrolyte inlets and electrolyte outlets provide for movement of electrolyte across the flow path.

In various embodiments, there may be included any one or more of the following features of the method: the decontamination chamber further includes at least two electrodes, the flow path passing between the at least two electrodes and the at least two electrodes configured to induce vertical movement of the electrolyte within the slurry; the at least two electrodes comprise at least one cathode and at least one anode having a DC current passing between them to induce vertical electrolyte movement within the flow path from the at least one anode to the at least one cathode; horizontal hydraulic pressure above atmospheric pressure is applied to the slurry within the decontamination chamber to induce movement through the flow path to the outlet; the electrolyte is introduced into the decontamination chamber at the electrolyte inlets adjacent to the at least one anode and the electrolyte exits the decontamination chamber at the electrolyte outlets adjacent to the at least one cathode; electrolyte that is introduced to the electrolyte inlets at above atmospheric pressure to induce movement of the electrolyte through the flow path to the electrolyte outlets; and the at least two electrodes further comprise a plurality of cathodes and a plurality of corresponding anodes together forming a plurality of corresponding cathode and anode pairs having a DC current passing between them to induce vertical electrolyte movement within the flow path from the plurality of anodes to the plurality of cathodes.

These and other aspects of the system and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a schematic showing decontamination equipment assembled on site and decontaminating soil according to one embodiment.

FIG. 2 is a schematic showing the operation of a mixing unit, a treatment unit and an electrolyte mixing tank and related components.

FIG. 3 is a schematic showing details of a slurry mixing tank and related components.

FIG. 4 is a schematic showing the detailed flow of electrolyte fluid and chemicals in the electrolyte mixing tank according to one embodiment.

FIG. 5 is a schematic showing the decontamination and dewatering chamber processes and related components according to one embodiment.

FIG. 6 is a schematic showing the flow of the soil and electrolyte through the decontamination and dewatering sections of the process according to one embodiment.

FIG. 7 is a schematic showing the onsite spent electrolyte refurbishment system according to one embodiment.

FIG. 8 showing the side and end views of stacked treatment units according to one embodiment.

FIG. 9 is a graph showing the relationship between the dissociation equilibrium for different soil and electrolyte concentrations.

FIG. 10 is a graph showing the relationship between porosity and the hydraulic conductivity coefficient for a different soil types.

FIG. 11 is a graph showing the relationship between porosity and the electroosmotic permeability coefficient for a kaolinite-dominated soil.

FIG. 12 is a graph showing electromigration rate as a function of sodium concentration and voltage gradient for a kaolinite-dominated soil.

FIG. 13 is a schematic diagram of an exemplary control system for the decontamination system.

### DETAILED DESCRIPTION

In an embodiment, there is an ex situ electrokinetic system and method for decontaminating soils and other fine-textured media, including salt-contaminated soil. The system consists of a series of unit processes that continuously remove inorganic and organic contaminants yielding a final decontaminated product. The initial soil conditioning unit process produces a homogenous slurry saturated with an electrolyte customized based on the types and concentrations of contaminants and the soil characteristics. The next unit process uses electroosmosis and electromigration along with hydraulic pressure to move electrolyte and dissolved contaminants through the slurry. The contaminants are released into the electrolyte and removed at the cathodes. The last unit process removes residual electrolyte and contaminants producing a final product suitable for land application or other uses. The method comprises the coordinated operation of these unit processes to optimize the removal of contaminants.

The contaminated soil is excavated and screened to remove large objects (e.g., rocks, stones, gravel, debris, woody material). The screened soil is fed into a mixing system at a controlled rate where an electrolyte is added at a prescribed rate to yield a homogenous slurry with a specified electrolyte content. The slurry is fed, at a controlled rate under pressure, into the decontamination unit process that comprises at least one cathode and one anode. A DC current at a controlled rate is passed between the electrodes and the dissolved contaminant ions migrate toward the electrodes having the opposite charge by means of electromigration. At the same time, electroosmosis pulls the electrolyte toward the cathode. This movement of contaminant ions and electrolyte is assisted by a regulated hydraulic pressure gradient that decreases in the direction of the cathodes and in the direction of the outlet. The rate of movement of the contaminant ions and electrolyte is controlled by the amount of applied power to the electrodes and the amount of hydraulic pressure applied to the slurry and to the electrolyte. The partially decontaminated slurry is fed at a controlled rate through a dewatering chamber process. The dewatering chamber process comprises at least one cathode and one anode. A DC current is passed between the electrodes. The separation distance between the electrodes decreases as the slurry moves through the dewatering chamber process by the gradual narrowing of the vertical space between the electrodes. This narrowing causes the voltage gradient to increase causing the electrolyte flow rate to increase while maintaining the desired hydraulic pressure despite a reduction in the volume of the slurry. As the slurry passes through the dewatering chamber process, additional electrolyte and residual contaminants are removed by means of hydraulic pressure, electro-osmosis and electromigration. The residual amount of contaminant at the end of the process is controlled by the strength of the DC current, the chemistry of the electrolyte and the residence time of the soil in the dewatering chamber process. The flow of the slurry through the unit-processes and applied power and hydraulic pressure may be controlled by an integrated SCADA.

Embodiments of the disclosed methods and systems are proposed in an attempt to overcome the economic, practical and treatment performance limitations of the prior art. It is hoped that one or more of the embodiments disclosed is able to provide a continuous ex situ electrokinetic decontamination method and system for the removal of contaminants from medium and fine-textured soil, which:
a. may be able to reduce the overall cost to achieve government-regulated, or otherwise desirable, residual soil contaminant levels;
b. may decrease the capital and operating costs associated with decontamination (e.g., may reduce heavy equipment, transportation, reclamation and labour costs);
c. may reduce the impact of the disposal of contaminated soil on available landfill disposal capacity;
d. may reduce the amount of contaminated fluid resulting from decontamination operations and that requires treatment and/or disposal following decontamination operations;
e. may reduce the time required to achieve adequate decontamination;
f. may increase the level of decontamination that can be achieved;
g. may increase the consistency of contaminant removal throughout the soil;
h. may allow the throughput of contaminated soil to be optimized so that decontamination can occur efficiently and reliably in a relatively short period of time;
i. may increase an operator's control over a decontamination process so that the rate of decontamination and the final level of residual contaminants can be regulated directly in real time; and/or
j. may increase the ability to reclaim contaminated land to a useful purpose and may increase the productivity of that land for future agricultural, industrial, commercial or other purposes

In embodiments of the method and system, there is disclosed a method and system of decontaminating soil using electrokinetics. The preferred embodiment may comprise one or more of the following steps:
a. screening the contaminated soil to remove large objects that may interfere with the flow of the soil through the treatment unit,
b. conditioning the soil by adding and thoroughly mixing a customized electrolyte,
c. feeding the contaminated soil slurry to the decontamination equipment,
d. conducting hydraulically assisted, electrokinetic decontamination in a vessel where the electric field, electrolyte content and hydraulic pressure gradient are closely controlled, and
e. removing residual electrolyte and contaminant(s) from the soil using electrokinetics and hydraulic pressure prior to discharge of the finished product.

In yet another embodiment, there may be provided a method of applying said electrolyte in a counter-current flow pattern that may significantly reduce the volume of spent electrolyte requiring treatment and/or disposal and the level of decontamination that can be achieved.

In yet another embodiment, removal of different contaminants may be achieved by sequentially applying different electrolytes designed specifically to remove specific contaminants. Sequential decontamination may be achieved within one treatment unit or by connecting multiple treatment units in series.

In yet another embodiment, the coarser material separated during the screening of the soil may undergo washing. The water from this washing may be used in the electrolyte mixing process and any suspended fine soil particles may be part of the slurry sent to the treatment unit. The need for this washing of these coarser particles may depend on the contaminant load held by them and the regulatory or other requirements in terms of the residual contaminant concentrations after treatment.

In yet another embodiment, a final quiescent compartment may be located at the outlet of the mixing tank. Coarser particles may settle to the bottom of this compartment. These coarser particles may be removed continuously and washed using water. The water from this washing may be used in the electrolyte mixing process and any suspended fine soil particles may be part of the slurry sent to the treatment unit. The need for this quiescent compartment may depend on the particle size distribution of the soil and the contaminant load held by different size fractions. These soil characteristics will vary from one site to the other.

At the outset, it is noted that the exemplary embodiments of the systems and methods are described below in the context of decontaminating salt-contaminated soils associated with oil and gas wells. However, the present embodiments are not limited to this application generally or specifically but comprehends electrokinetic decontamination of many types of contaminated soils, no matter how or where they are lying, collected and contained or deposited. Without limitation, other contaminated soils that are comprehended by the present embodiments may include drilling mud, municipal and industrial sludges, contaminated industrial, commercial, residential and agricultural sites and contaminated freshwater, and marine sediments and dredging spoils. Contaminants that are comprehended by the present embodiments may include inorganic contaminants such as heavy metals and other toxic inorganic ions and organic contaminants such as fuel, oil, grease, solvents, herbicides and pesticides, and other toxic organic compounds. These materials may be hazardous to human health or the environment and may persist in the environment for a long time without intervention.

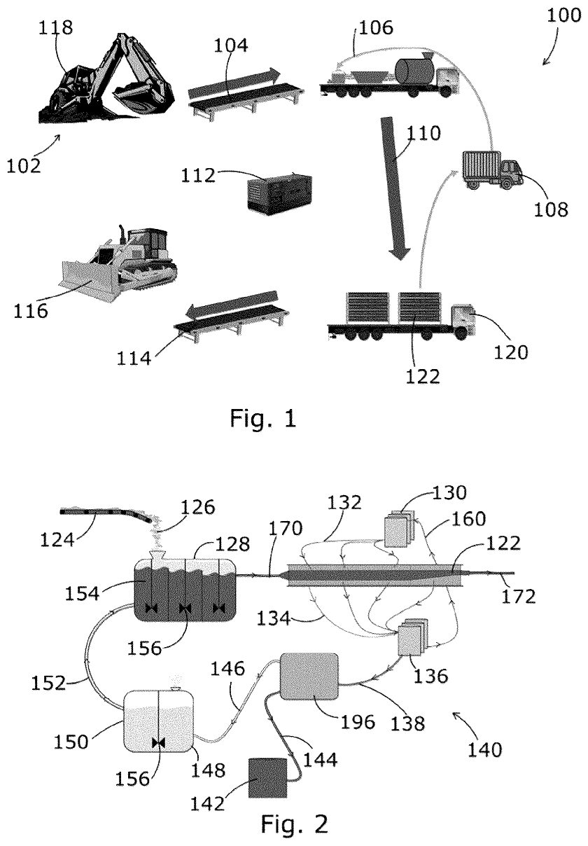

As shown in FIG. 1, in an embodiment, there is decontamination equipment assembled on a work site 100. An excavator such as a hi-hoe 118 may be used to excavate contaminated soil 102. The contaminated soil may be placed on a conveyor 104 (or whatever other material handling system is desired and is available) and transported to a soil preparation unit. A soil preparation unit may be used to screen the soil. The soil preparation unit may remove material above a certain size prior to further processing. Screening may remove stones and large objects. The screened soil is sent to a soil conditioning unit 106; this unit may be at a fixed location or mounted on a portable trailer as shown in FIG. 1. The soil conditioning unit mixes electrolyte into the soil to form a slurry. The electrolyte may be provided to the soil conditioning unit from an electrolyte refurbishment unit 108, which may also be portable. Each of the components of the conditioning and decontamination processes may be mounted on the same or different portable units or may be permanently installed together at a single location or at separate locations. Various stages of the treatment process may be conducted at the same or separate locations.

After conditioning, the slurry is moved by a pipe 110 to the decontamination system 120, which may include a plurality of treatment units 122. The conditioned slurry is fed to the decontamination units under pressure. The decontaminated soil from the decontamination system may be handled by transportation mechanisms such as conveyor belts 114 where it may be moved to a separate location or returned to the original site. Decontaminated soil may be transported using the excavator 118 or other moving equipment such as a bulldozer 116. The decontaminated soil is conveyed to where it will be replaced. In some embodiments, the decontaminated soil is used to fill the hole from which it was excavated.

The spent electrolyte may be sent from the treatment unit(s) to an onsite refurbishment process 108. The refurbished electrolyte is then reused in the soil conditioning process. The system can be powered with a diesel generator 112 or local power if available or renewables.

The decontamination system 120 is shown with a plurality of treatment units stacked on a flatbed, which may be transported to a project site. In some embodiments, the length of the units are designed to be equal to the width of a flatbed. This design allows easy access to the inlets and outlets of each unit and maximizes packing efficiency. With a width of 2 m per unit, a maximum of 8 stacks of units per flatbed is possible on a standard flatbed. Depending on height regulations and the size of the units, the maximum number of units per stack may be 12. Accordingly, in some embodiments a total of 96 units can be deployed per flatbed. The treatment units may be loaded on the flatbed by various loading mechanisms such as a forklift loader. Each treatment unit may be run independent of the other units. The throughput of the installation may be customized to a project by adding or removing units. Once the system is on site, the units may remain on the flatbed.

System startup involves connecting the soil conditioning unit, the electrolyte reservoirs and the electrical power to the treatment units. Each unit has a throughput capacity of 0.3 to 0.8 m³/hour depending on the hydraulic conductivity and electroosmotic permeability coefficient of the soil being decontaminated. As well, the internal voltage gradient, the types of contaminants to be removed, and the final residual contaminant concentration affect the throughput capacity. Conservative assumptions (i.e., those likely to produce low throughput estimates) have been used. The result is that with some embodiments, a fully loaded flatbed system can decontaminate 30 to 75 m³ of contaminated soil per hour.

As shown in the embodiment in FIG. 2, the details of a decontamination system 140 are shown. Screened soil 126 may be added to a slurry mixing tank 128 using a mover such as a conveyor belt 124. The soil is mixed with electrolyte in the slurry mixing tank to form a slurry 154. The soil may be mixed with impellors 156. Impellors of various designs, or other mixers, may be used in this and other mixing tanks. The slurry may be pumped through a line 170 into the treatment unit 122. Additional electrolyte may be introduced into the treatment unit from electrolyte reservoir 130 through lines 132. Spent electrolyte is collected in a spent electrolyte collection tank 136 through lines 134. Spent electrolyte may be passed into a refurbishing unit 196 through one or more lines 138. The refurbished electrolyte from the refurbishing unit may pass through line 146 into an electrolyte mixing tank 150. The electrolyte 148 within an electrolyte mixing tank may be added to the slurry mixing tank along line 152. Contaminants removed by the refurbishing unit 196 may be placed in a storage tank 142 using line 144 and stored on site until they are removed for disposal or further treatment.

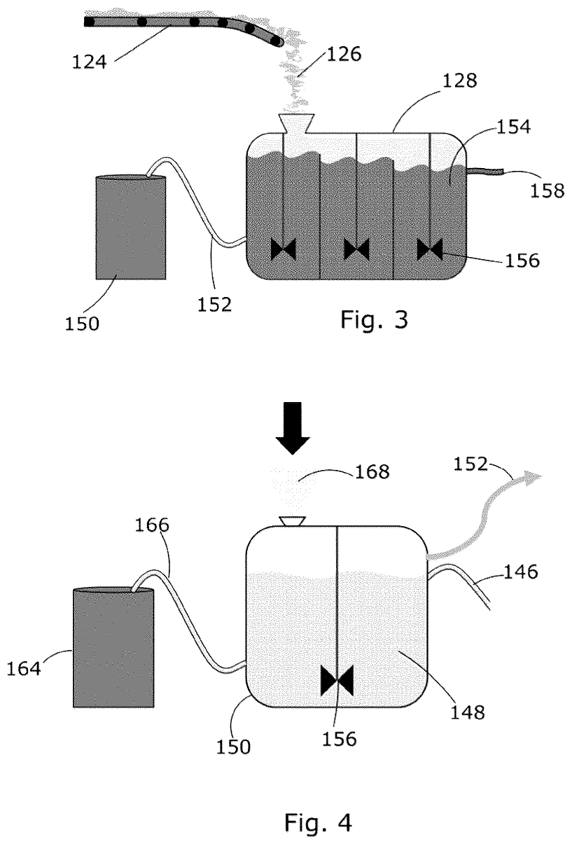

The flow of screened soil and electrolyte in the mixing tank is shown in more detail in FIG. 3. Screened soil 126 is added at a controlled rate using a conveyor 124 (or other suitable soil handling method) and electrolyte is added at a controlled rate from the electrolyte mixing tank 150 using line 152. These two additives are thoroughly mixed in the slurry mixing tank 128.

The flow of fluid and chemicals to and from the electrolyte mixing tank 150 are shown in FIG. 4. Dry electrolyte chemicals 168 may be added at a controlled rate into the electrolyte mixing tank. The dry chemicals are mixed with water or other solvents to form the desired electrolyte composition. The solvent may be added at a controlled rate into the electrolyte mixing tank from a solvent reservoir 164 using line 166. The mixed electrolyte 148 flows from the electrolyte mixing tank to the anodes in the treatment units through line 146 and to the slurry mixing tank through line 152.

An exemplary treatment unit 122 is shown in FIG. 5. The slurry is continuously passed through a flow path in a contiguous series comprising a decontamination chamber 178 and a dewatering chamber 180. The flow path runs from an inlet 184 and to an outlet 186. Each of the decontamination chamber 178 and the dewatering chamber 180 include at least two electrodes 174, 176. The flow path passes between the at least one anode and at least one cathode in the decontamination chamber and the at least one anode and at least one cathode in the dewatering chamber. The at least two electrodes in each of the decontamination chamber and the dewatering chamber are configured to induce movement of the electrolyte within the slurry toward the cathode(s).

In some embodiments, the decontamination chamber and dewatering chamber together form the reaction vessel which is made of nonconducting materials and is contained in an external metal frame basket that adds strength and facilitates handling and stacking. The dimensions of a commercial unit may be 2 m×3 m in width and length, respectively. The height inside the decontamination chamber is uniform and is 0.15 m. The height inside the dewatering chamber is sloping toward the outlet decreasing from 0.15 m to 7.5 at the outlet. The total volume of the treatment unit may be about 0.83 m³.

As the slurry moves through the treatment unit from left to right, electrolyte is forced vertically through the slurry using a combination of electroosmosis and hydraulic pressure. Fresh electrolyte is fed into the unit from the anodes at the top and spent electrolyte is collected at the cathodes at the bottom. As the slurry moves through the unit from the inlet to the outlet, the contaminant concentration decreases as indicated by the shading pattern. The first section of the treatment unit, namely the decontamination chamber, comprises the primary decontamination stage.

In the next section, namely the dewatering chamber, no electrolyte is added. However, spent electrolyte is removed from the slurry at the cathodes by means of electroosmosis and hydraulic pressure. Removal of this electrolyte further reduces the level of contamination in the soil as indicated by the shading pattern. At the same time, the proportion of electrolyte in the soil decreases causing the slurry to become increasing more solid.

At the end of the process, decontaminated soil is released through the outlet 186 into a line 172 (or other suitable soil handling method) for onsite spreading or other desired uses.

The flow rate of the slurry through a treatment unit is governed by the rate at which the electrolyte moves through the slurry and by the final residual contaminant concentration in the treated soil that needs to be achieved. The throughput increases as the rate of electrolyte flow increases and/or as the maximum residual contaminant level is increased.

The at least one anode and at least one cathode in the decontamination chamber and the at least one anode and at least one cathode in the dewatering chamber may include multiple cathode and anode pairs having a DC current passing between them. In the embodiment shown in FIG. 5, there are five anode and cathode pairs. Three anodes and cathodes are positioned in the decontamination chamber and two anode and cathode pairs in the dewatering chamber. The power applied to each electrode pair may be varied among them.

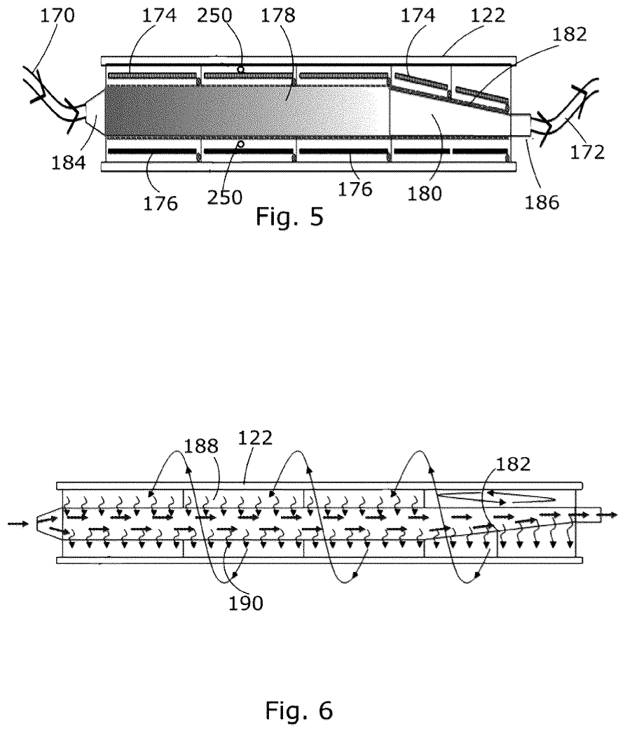

The flow path is defined by the inner walls of the chambers. The decontamination chamber and the dewatering chamber are contiguous with one another. The slurry flows directly into the dewatering chamber from the decontamination chamber. In the embodiment shown in FIG. 5, the cross-sectional area of the decontamination chamber is constant, whereas in the dewatering chamber, the cross-sectional area reduces toward the outlet. As shown in FIG. 5, the upper wall 182 of the dewatering chamber decreases in height towards the outlet. Each of the corresponding cathode and anode pairs in the decontamination chamber are separated by at least a minimum distance and the at least two electrodes in the dewatering chamber are separated by a second distance with the minimum distance larger than the second distance. The distance between cathode and anode pairs adjacent to the inlet are larger than the distance between cathode and anode pairs adjacent to the outlet. In other embodiments, the reduced cross-sectional area of the dewatering chamber may be structured in different ways, such as having the base of the dewatering chamber increase in height towards the outlet 186 as shown in FIG. 6. The change in cross-section need not be linear or have any particular structure.

When power is applied to the electrodes, an electrolytic reaction with the electrolyte is induced. When water is the solvent used in the electrolyte, the electrolytic reactions cause gas to be produced. At the anodes, the water is electrolyzed, and hydrogen ions (H⁺) are released into the electrolyte and oxygen gas is produced. At the cathodes, the water is also electrolyzed except that hydroxide ions (OH) are released into the electrolyte and hydrogen gas is produced. This gas can interrupt the process if it is not released out of the treatment unit. As shown in FIG. 5, gas vents 250 allow the gases produced at the cathodes and anodes to exit the treatment unit. There may be gas vents on all electrodes in the decontamination chamber and dewatering chamber. Alternatively, multiple cathodes and multiple anodes may each be connected to a common gas vent as long as there are pathways for produced gas to exit the treatment unit from each electrode.

The slurry enters the treatment unit under pressure and moves continuously from left to right. In some embodiments, dimensionally stable anode plates in sealed chambers filled with electrolyte are positioned along the top of the decontamination section. Fresh electrolyte is continuously fed into the anode chambers under pressure.

In some embodiments, stainless steel cathode plates in sealed chambers are positioned along the bottom of the treatment unit. Spent electrolyte enters the cathode chambers and is drained continuously into a collection reservoir(s) 136 (FIG. 2).

When power is applied, electroosmosis drags the electrolyte from the anodes to the cathodes. This movement of electrolyte is assisted by the downward hydraulic pressure gradient. At the same time, dissolved cations in the electrolyte are drawn down toward the cathode(s) by means of electromigration. Dissolved anions are drawn upward toward the anode(s).

As the electrolyte moves through the slurry, contaminants are dissolved in, or adsorbed to, the electrolyte and may be replaced with desirable ions dissolved in the electrolyte. The movement of electrolyte in from the anodes and out from the cathodes is balanced such that the volume and density of the slurry remains constant in the decontamination section.

Anode and cathode are also present within the dewatering chamber. However, no fresh electrolyte is added. Instead, the electrolyte in the slurry is drawn down toward the cathodes on the bottom. The result is that the overall volume of the slurry decreases while its density increases. The downward sloping top section of the dewatering chamber accommodates this decrease in volume while maintaining the lateral hydraulic pressure gradient.

As electrolyte is removed from the slurry, the density increases and the slurry may be transformed into a thick paste. The decontaminated solids are released out the outlet. The decontaminated solids may be used to fill in the excavation from which the contaminated soil was removed.

In some embodiments, the separation distance between the electrodes in the treatment chamber may be fixed at a distance such as 0.15 m. In the dewatering chamber, the separation distance gradually may diminish to 0.075 m. The greater is the separation between the electrodes, the longer is the time required for the electrolyte to move from the anodes to the cathodes and for full decontamination to be achieved. As well, the greater is the separation distance, the greater is the power demand. On the other hand, the separation distance limits the volume of soil being decontaminated at each point in time; the greater the separation distance, the more soil that is being treated but the flow rate of the slurry through the treatment unit is less, everything else being equal. The 0.15 m distance between electrode pairs has shown positive results and is a tradeoff among these considerations. Future designs might have the electrodes closer together or further apart depending on the desired performance metrics. In some embodiments the treatment chamber may have the following dimensions: L=3 m, W=2 m, T=0.15 m.

Electrolyte is added and removed in the decontamination chamber. Electrolyte is only removed in the dewatering chamber. Although the decontamination chamber and the dewatering chamber are described as separate chambers, there are no significant structural divisions at the threshold between the two chambers. The differences between the decontamination chamber and the dewatering chamber relate largely to the function of the two chambers. The decontamination chamber largely removes contaminants due to a balanced flow of electrolyte in and out resulting in a slurry with a constant density and decreasing contaminant concentrations; whereas, in the dewatering chamber, electrolyte and contaminants are only removed and the density of the slurry increases. In some embodiments, the dewatering chamber may narrow towards the outlet.

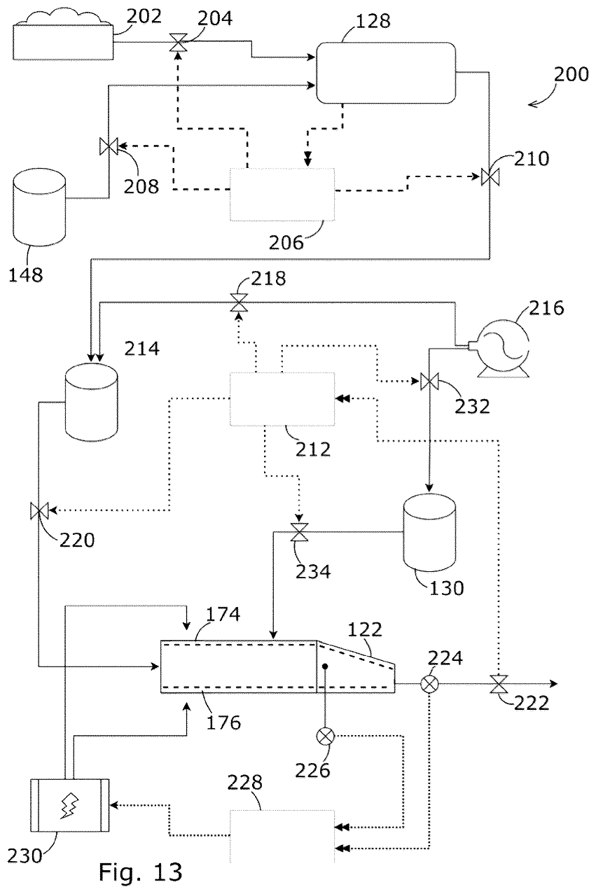

A positive hydraulic pressure gradient may be created from the anodes to the cathodes in the decontamination chamber to induce electrolyte movement within the flow path toward the cathodes. A hydraulic pressure source 216 (FIG. 13) may create a pressure gradient in the system and the flow of the slurry may be controlled by a valve 186 formed integrally as part of the outlet. After exiting the outlet, the processed slurry enters the line 172. The valve and outlet are shown as integrally formed in FIG. 5 but other configurations may be used such as a separate valve 222 as shown in FIG. 13.

A horizontal hydraulic pressure gradient may be maintained from the inlet to the outlet above atmospheric pressure. A horizontal pressure is applied through the slurry entering at the inlet. In general, the horizontal pressure along the flow path decreases toward the outlet. The horizontal pressure gradient within the decontamination chamber and the dewatering chamber induces movement of the slurry through the flow path from the inlet to the outlet.

A vertical pressure is applied through the electrolyte coming from the anode(s). This vertical pressure gradient induces movement of the electrolyte toward the cathodes. The vertical pressure gradient is constant along the length of the decontamination chamber but may decrease through the dewatering chamber.

Pressure may applied pneumatically. An air pressure system similar in concept to the pneumatic systems used for framing and roofing may be used. A pressure gauge may be used to control the compressor and to maintain the pressure within a specified operating range. Pressure may be maintained with a pig as with other pneumatic systems. When the pressure in the pig drops below a threshold level, the compressor automatically starts up and repressurizes the pig to the maximum operating level.

The pressure and applied power are balanced so that the volume of spent electrolyte is minimized while achieving the desired level of decontamination. The residual level of contamination in the final product is constantly monitored and fed back to the control system. When greater/less contaminant removal is needed, the electric field strength and/or pressure are increased/decreased accordingly. As the electric field and/or pressure are increased/decreased, the rate of contaminant removal increases/decreases.

The applied power level determines the electric field strength which in turn, determines the electroosmotic velocity of the electrolyte through the slurry. If a higher velocity is desirable (i.e., more flushing action is required), the electric field strength may be increased. As the flushing velocity increases, the throughput of the system may be increased (i.e., the contaminant removal rate increases). The flushing rate may be controlled by both the applied pressure and the electric field strength. The process may be operated to achieve the highest level of throughput and the desired residual contaminant concentration(s) for the lowest cost. Reducing the electrolyte velocity is less expensive in terms of power and the volume of spent electrolyte but the treatment process takes longer. In some embodiments, power levels up to 200 V/m may be used but higher power levels are feasible, for example, in embodiments where the electrodes are 0.15 m or less apart.

Three primary control variables may be used to control the level of decontamination during operations: the applied power, the applied pressure and the rate that decontaminated soil is released from the unit. Increasing/decreasing the rate that electrolyte flows through the soil and increasing/decreasing the rate that the soil moves through the unit, increases/decreases the level of decontamination.

Tracking the contaminant concentration in the spent electrolyte may provide feedback for regulating the applied power, the applied pressure and the throughput rate. Measurement of contaminant concentration(s) in the spent electrolyte may provide a measure of the amount and rate of contaminant removal. Measurement of contaminant concentration(s) in the spent electrolyte depends on the nature of the contaminant(s). For example with sodium, changes in electrical conductivity can be used as an indicator of the sodium concentration in the spent electrolyte.

Measurement of contaminant concentration(s) in the decontaminated solids at the outlet may provide a direct measure of the amount of contaminant removed. In situ, real-time measurements of the contaminant concentration in the slurry may be preferred but measuring contaminant concentrations in the spent electrolyte and in the decontaminated solids may provide adequate feedback for the operation of the process. Based on these monitoring data, the applied power, the applied pressure and/or the throughput rate may be adjusted accordingly.

The contamination and electrolyte content may be monitored during the treatment process by measuring electrical conductivity. The electrical conductivity may decrease as the contaminant concentration decreases.

As shown in FIG. 6, fresh electrolyte is introduced into the decontamination chamber adjacent to the anodes 174 (FIG. 5) and the spent electrolyte exits the decontamination chamber adjacent to the cathodes 176 (FIG. 4). The flow of fresh electrolyte at the anodes is shown generally by the arrows 188. The flow of spent electrolyte at the cathodes is shown generally by the arrows 190. The electrolyte is introduced at the anodes at a rate sufficient to maintain a constant slurry density. The rate of electrolyte flowing out at the cathodes may not be controlled directly and may be a function of the hydraulic conductivity and electroosmotic permeability of the slurry, the applied power and the applied pressure. The inflowing fresh electrolyte may be above atmospheric pressure to induce movement of the electrolyte through the flow path to the cathodes.

Corresponding cathode and anode pairs may have a DC current passing between them to induce electroosmotic and electromigration flow through the slurry along the flow path between the plurality of anodes to the plurality of cathodes. An applied power across the electrodes in each of the decontamination chamber and the dewatering chamber may be modified while the slurry passes through the flow path to control the rate of contaminant removal. A flow rate of the slurry along the flow path may be controlled by means of the adjustable valve on the outlet 186 (FIG. 5).

The electrolyte collected at the cathodes may be recycled using a countercurrent flow pattern after exiting the decontamination chamber and the dewatering chamber (FIG. 6).

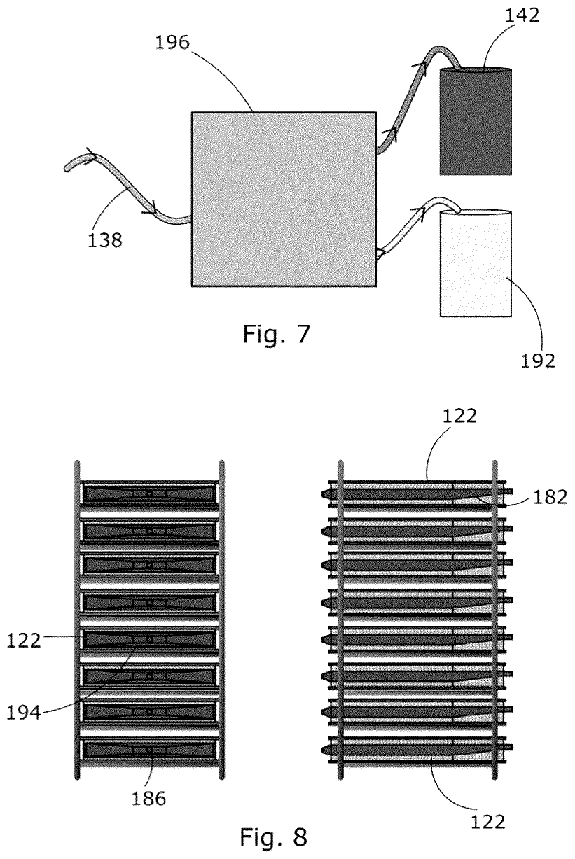

As shown in FIG. 7, the electrolyte collected at the cathodes may be sent by line 138 for refurbishment after exiting the decontamination chamber and the dewatering chamber. The electrolyte that exits the decontamination chamber and the dewatering chamber may be subsequently refurbished with the onsite electrolyte treatment system/refurbishing unit 196. The refurbished liquid may be stored in an electrolyte storage reservoir 192 and then pumped to the electrolyte mixing tank 150 (FIG. 4). The concentrated contaminants from the refurbishment unit may be stored in a tank 142 and periodically shipped off site for disposal.

FIG. 8 shows side and end views of embodiments of stacked treatment units. In the embodiments shown, the inlet and outlet have the shape of round pipe. The funnel-shaped entrance and exit ports receive the slurry and discharge the decontaminated soil respectively. An end of the funnel-shaped exit 194 is shown in the end view on the left side of FIG. 8 which also shows the outlet 186. The side view is shown on the right side of FIG. 8. In other embodiments, the outlet may be the same width as the dewatering chamber with a suitable end valve, such as a knife gate valve, to control the fluid flow out of the treatment units. Each treatment unit has a flow path between the inlet and the outlet.

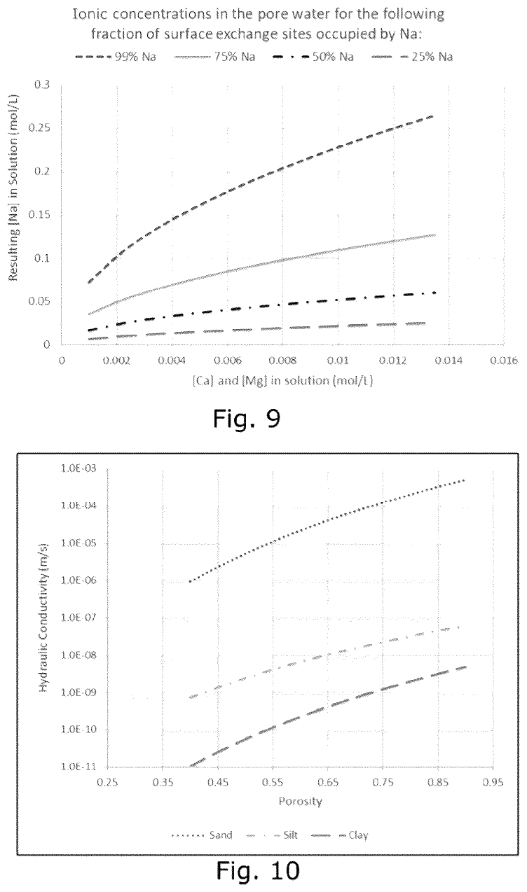

FIG. 9 shows the relationship between the dissociation equilibrium for different soil and electrolyte concentrations. The dissociation equilibrium varies with the type of contaminant(s) to be removed and the chemistry of the electrolyte. The dissociation equilibrium determines the amount of contaminant that can be removed at a given point according to the nature of the electrolyte. The total amount of electrolyte required to achieve a specified residual contaminant concentration is directly dependent on the corresponding dissociation equilibrium. The dissociation constant varies with the nature of the contaminant(s) to be removed, their concentrations and the electrolyte composition. By modifying the electrolyte composition for different applications, the volume of electrolyte need for decontamination varies. For this reason, the electrolyte composition may vary from one application to another and determining the optimal electrolyte concentration may be an important decision.

FIG. 10 shows the relationship between porosity and the hydraulic conductivity coefficient for a kaolinite-dominated soil. The hydraulic conductivity partly determines the rate at which electrolyte can be pushed through the soil under a specific hydraulic pressure gradient. As the hydraulic conductivity increases, the electrolyte flow rate increases increasing the achievable throughout of a treatment unit. As the electrolyte flow rate increases, the contaminated soil throughput of the unit increases.

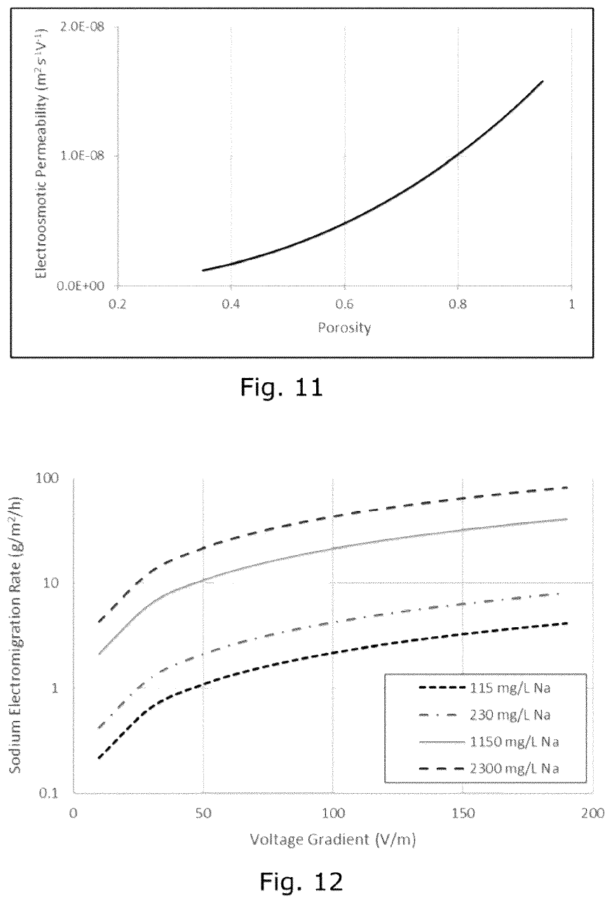

FIG. 11 shows the relationship between porosity and the electroosmotic permeability coefficient for a kaolinite-dominated soil. The electroosmotic permeability partly determines the rate at which electrolyte can be dragged through the soil by electroosmosis under a specific voltage gradient. As the electroosmotic permeability increases, the contaminated soil throughput of the unit increases.

FIG. 12 shows the electromigration rate as a function of sodium concentration and voltage gradient. The electromigration rate partly determines the rate at which contaminants can be dragged out of the slurry under a specific voltage gradient. As the electromigration rate increases, the contaminated soil throughput of the unit increases.

FIG. 13 is a schematic diagram of an exemplary control system 200 for the treatment system. Screened soil 202 may be fed into a mixing tank 128. The flow rate of the screened soil may be controlled by a flow control system 206 through a valve 204 between the screened soil and the mixing tank 128. A rate of flow of the electrolyte may be controlled by a flow control system through a valve 208 between the electrolyte tank 148 and the mixing tank. A rate of flow of the slurry out of the mixing tank may be controlled by a flow control system through a valve 210 between the mixing tank and a pressurized feedtank 214. A pneumatic pressure system 216 provides pneumatic pressure to the system. A pressure control system 212 controls various flow valves in the system. A rate of flow of air or pressurized fluid may be varied using a valve 218 between the pneumatic pressure system and the pressurized feedtank; this valve may be controlled by the pressure control system 212. From the pressurized feedtank, a rate of flow of the pressured slurry may be controlled by the pressure control system using a valve 220. A flow rate of air or other pressurized fluid between the pneumatic pressure system and the pressurized electrolyte tank 130 may be controlled by the pressure control system using a valve 232. A rate of flow of electrolyte into the anodes 174 may be controlled by the pressure control system using a valve 234 between the pressurized electrolyte tank and the treatment unit 122. A flow rate of treated slurry exiting the treatment unit 122 may be controlled by the pressure control system using a valve 222 after the outlet of the treatment unit. Various sensors 224, 226 may be used and the data may be reported to either or both the pressure control system and a voltage control system 228. A sensor 224 may be placed after the outlet of the treatment unit and may detect the density and the residual contaminant concentration of the treated solids, as well as other properties of the solids. The sensor 226 may be placed within the dewatering chamber to determine the concentration of contaminant(s) at a given stage in the decontamination process. The power supply 130 may be controlled by the voltage control system regulating the power supplied to the anodes and cathodes.

The flow control system, the pressure control system and the voltage control system are each shown as separate units in FIG. 13 for ease of reference, but it will be understood that the functionality of each of these systems may be contained in a single unit or as separate units. The valves, sensors and control units may be connected by wireless or wired connections. Various different types of sensors and valves may be used. Sensors may be used in various locations within the system to detect any of the properties discussed in this application to assist with the soil treatment process.

The control system may include hardware and software components. The control system software may be a standard SCADA. The program is provided with operating ranges for key parameters. The internal logic provides directions as to what to do when a certain condition arises.

The SCADA may be used to balance the flow through the system by monitoring the rate of discharge of finished product. A primary control point is the rate at which finished product is released from the treatment unit. Secondary control points include the rate at which slurry is released from the pressurized feedtank and that electrolyte is fed to the anodes. This mass balancing is achieved by balancing the volume in with the volume out including solids and electrolyte.

Another control variable is the solids density/viscosity/porosity of the slurry produced at the start of the process. The volume of screened soil and electrolyte may be balanced to achieve the desired slurry density. The optimal slurry consistency may vary with soil type, the nature and concentration of the contaminants and the desired throughput rate. The SCADA may be programmed for each project based on these factors and/or other factors.

The applied pressure determines the throughput rate and may vary from one project to the next. The SCADA may be designed to maintain the pressure within a desired operating range for a given project. If the throughput rate is to be increased/decreased, the pressure may be adjusted and the rate at which finished product is being discharged may be adjusted.

The control system hardware may include the computer on which the control program is loaded and the interfaces (PCBs) that operate switches and valves. The software communicates with these PCBs which in turn provide directions to the individual control mechanisms for the required adjustments. These control mechanisms may be automated.

Sensors may be used to track key operating parameters and to relay this information back to the control system.

“Off-the-shelf” switches, control valves and monitoring devices may be used. FIG. 13 shows the control points but does not provide specifications for each device. These specifications may be largely determined by the specifications for the available standard devices.

In an embodiment, there is disclosed a method of facilitating decontamination of soil through application of hydraulic pressure. The feasibility of this embodiment may be determined by the porosity of the soil to be decontaminated and its hydraulic conductivity. An electrolyte may be mixed into the soil to form a slurry. The slurry may be passed through a flow path in a decontamination chamber and a dewatering chamber at a hydraulic pressure above atmospheric pressure, the flow path extending between an inlet and an outlet. The decontamination chamber may include electrolyte inlets on the top and electrolyte outlets on the bottom. A vertical pressure gradient may induce flow through the slurry electrolyte across the flow path from the electrolyte inlet to the electrolyte outlet. In this embodiment, the treatment may be caused by hydraulic pressure alone driving the movement of electrolyte through the slurry without the application of electric current. In other embodiments, it is possible for the treatment to be caused by the application of electrical current and electrolyte treatment alone without the application of hydraulic pressure to the electrolyte.

Embodiments of methods disclosed herein may include the following steps:
a. Testing of the contaminated soil to characterise the physical, chemical and electrical characteristics of said soil and the chemical characteristics of the contaminants in said soil;
b. Lab testing of different electrolyte formulations to determine:
   i. the most effective and economical (i.e., “best”) electrolyte “recipe” for removing said contaminant(s) from said soil, and
   ii. the optimal operating regime to maximise the amount of said contaminant(s) removed while minimizing the volume of spent electrolyte that is produced;
c. Procuring adequate quantities of the ingredients to produce enough volume of said electrolyte to remove the target mass of contaminants from the mass of contaminated soil to be decontaminated. This electrolyte may include specific concentrations of cations, bases or acids, buffering compounds, chelating agents including EDTA, surfactants, polar solvents and/or soil amendments;
d. Excavating said contaminated soil (FIG. 1);
e. Screening said contaminated soil to remove large stones, gravel, woody material and any other debris that might impede the flow of the soil through the treatment unit;
f. Feeding the screened contaminated soil directly into a mixing tank 128 (FIG. 3) or temporarily storing said screened contaminated soil in a pile or a storage hopper;
g. Continuously or intermittently adding a prescribed amount of said custom electrolyte into said mixing process such that a homogeneous slurry having a specified density and a specified electrolyte content is produced (FIG. 3);
h. Feeding under pressure and continuously said slurry 154 from said mixing process to a treatment unit 178 comprising at least one cathode and one anode between which a DC electric current is passed (FIG. 5);
i. Feeding under pressure and continuously said electrolyte at the anode(s) 174 as said slurry moves continuously through said treatment unit (FIG. 5);
j. Withdrawing continuously said electrolyte out of said contaminated slurry at the cathode(s) 176 as said slurry moves through said treatment unit (FIG. 6);
k. Feeding under pressure and continuously the partially decontaminated slurry into a dewatering chamber 180 comprising at least one cathode and one anode between which a DC electric current is passed (FIG. 5);
l. Withdrawing continuously said electrolyte out of said contaminated slurry at the cathode(s) as said slurry moves through said dewatering chamber (FIG. 6);
m. Subjecting said soil to an increasingly stronger electric field as it moves through said dewatering chamber;
n. Continuously monitoring the contaminant and electrolyte content in said soil at select locations between the inlet and outlet of the treatment unit;
o. Continuously monitoring, and adjusting as needed, the electric field and hydraulic pressure applied to the slurry and the electrolyte to control the residence time of the soil in the decontamination and dewatering chambers, to enhance the flow of electrolyte through the soil and to regulate the contaminant and electrolyte content of the final decontaminated soil;
p. Continuously monitoring, and adjusting as needed, the cross-sectional area of the outlet 186 from the dewatering chamber to control the residence time of the soil in the decontamination and dewatering chambers and to regulate the contaminant and electrolyte content of the final decontaminated soil (FIG. 5);
q. Withdrawing continuously decontaminated and dewatered soil from the outlet 186 of said dewatering chamber (FIG. 5);
r. Using said decontaminated and dewatered soil for onsite fill and reclamation or for other uses as appropriate;
s. Treating the spent electrolyte onsite and reusing the refurbished electrolyte in the decontamination process; and
t. Disposing of the concentrated contaminants onsite or offsite.

In some embodiments there is disclosed a system for decontaminating soil using electrokinetics. The preferred system may comprise one or more of the following components:
a. A screening unit to separate out large stones, gravel, woody material and any other debris that might impede the flow of the soil through the treatment unit;
b. A conveyor belt or other means to carry screened soil for temporary storage or for adding screened soil directly to a mixing unit (FIG. 1);
c. A storage hopper to temporarily hold said screened soil;
d. A conveyor belt or other means to carry screened soil from temporary storage to a mixing unit;
e. A slurry mixing tank 128 to mix said screened soil 126 (FIG. 3) with electrolyte 148 (FIG. 4);
f. A mixing reservoir 150 for mixing the electrolyte components, a reservoir for
g. holding dry or concentrated chemicals 168 and a reservoir for holding the electrolyte solvent 164 (FIG. 4);
h. Pumps and hosing 152 to feed electrolyte from said electrolyte mixing reservoir to said slurry mixing tank and hosing 146 to feed electrolyte from said electrolyte mixing reservoir to the anode chamber(s);
i. Pumps and hosing 170 to feed under pressure the contaminated slurry from said slurry mixing tank into a treatment unit 122 (FIG. 3);
j. A treatment unit 122 made of nonconductive material comprising a decontamination zone 178 and a dewatering zone 180 where contaminants are separated from the slurry using electrokinetic and hydraulic forces (FIG. 5);
k. At least one cathode and one anode in the decontamination zone and at least one cathode and one anode in the dewatering zone, all mounted on the opposing bottom and top walls of said treatment unit(s) (FIG. 5);
l. Electrodes chambers that are filled with electrolyte and are positioned on the opposing bottom and top walls of the treatment unit(s) and that house the electrodes (FIG. 5);
m. Pressurised external electrolyte reservoirs 130 that feed electrolyte under pressure through lines 132 into the anode chambers in the decontamination zone attached to the treatment unit 122 (FIG. 2);
n. Electrolyte collection reservoirs 136 connected by lines 134 to the cathode chambers in the decontamination and dewatering zones (FIG. 2);
o. Pumps and hosing to transfer contaminated electrolyte from said cathode reservoirs to upstream anode electrolyte reservoirs (FIG. 6);
p. Pumps and hosing 138 to transfer spent electrolyte to the spent electrolyte refurbishment unit(s) (FIG. 7);
q. Gas vents adjacent to said electrodes to release gas produced by the electrolytic reactions that occur within the decontamination and dewatering chambers,
r. Gas release valves on the top of the anode gas vents, s. A DC generator or rectifier to supply DC electric current (FIG. 1);
t. A spent electrolyte refurbishment system (FIG. 7);
u. A reservoir to collect concentrated contaminants from the spent electrolyte refurbishment system (FIG. 5);
v. Pumps and hosing to return decontaminated electrolyte from said electrolyte refurbishment system to the electrolyte mixing reservoir, and
w. A central control system consisting of hardware and software to regulate the flow of materials through the system, to adjust the rate at which electrolyte is added, to control the mixing rate in the mixing tank, to regulate the pressure applied to the slurry and to the electrolyte and to adjust the applied power to individual electrodes based on readings from in situ sensors.

An alternative arrangement of the system involves operating multiple decontamination and dewatering chambers in series. With this configuration, the composition of the electrolyte may vary from one set of units to the next. Configuring two or more sets of units in series may increase the amount and types of contaminants that may be removed and lowers the final residual contaminant concentration in the decontaminated soil. With this configuration generally, the residence time for full decontamination may be greater and the throughput for each unit, as measured by the rate that decontaminated soil is produced, may be lower even though the rate that the slurry moves through the treatment units may not change or may even be greater.

Another alternative arrangement of the system involves operating multiple decontamination and dewatering chambers in parallel. The units may be stacked one on top of another (FIG. 8). Configuring two or more sets of units in parallel does not affected the decontamination performance of each unit but increases the throughput by a factor equal to the number of parallel sets operating at one time.

The effectiveness of electrokinetic decontamination is strongly influenced by the applied power specification and related pattern and strength of the electric field between the electrodes, the chemical and physical characteristics of the soil to be decontaminated, the nature and concentration(s) of the contaminant(s) to be removed, the residence time of the soil in the treatment unit, the chemistry of the applied electrolyte, and the physical dimensions and arrangement of the treatment unit including its shape, surface area, composition and separation distance of the electrodes. The “recipe” for the electrolyte is customized for each application of the method and the operating regime is modified in terms of the applied power and the applied pressure to optimize the decontamination process.

Testing of the contaminated soil may be conducted prior to the deployment of a system. The soil may be tested for standard physical (e.g., particle size distribution, hydraulic conductivity), chemical (e.g., pH, contaminant type(s) and concentration(s), ion exchange capacity, buffering capacity) and electrical (e.g., conductivity, electro-osmotic permeability, zeta potential) characteristics. Additionally, electrokinetic small-scale tests may be run to test various custom electrolyte “recipes” and to determine the best recipe and the best applied power schedule for a specific application.

A large literature exists relating to the dynamics of different types of contaminants in different types of soils (e.g., Bech, 2021) and the use of electrokinetics to remove soil contaminants (Chen et al, 2021, Han et al, 2021, Wen et al, 2021). The most effective chemical mixture to flush contaminants out a soil varies with the type(s) and concentration(s) of contaminants and the soil characteristics. The concentrations of the chemical components in each custom electrolyte may vary but common chemicals added to remove inorganic contaminants include: divalent ions (e.g., Ca++, Mg++ to displace adsorbed ions like Na+), buffers (e.g., acetic acid, calcium carbonate to adjust the pH so that zeta potential is improved and in turn, the effectiveness of electrokinetic process is improved and the mobility of some contaminant ions is increased), and/or binding or chelating agents (e.g., EDTA that binds with some species of heavy metal ions). Common chemicals that are added to remove nonpolar organic contaminants may include surfactants (cationic and anionic) and oxidizing agents (e.g., hydrogen peroxide) to breakdown insoluble long-chain organics and to make the byproducts susceptible to transport by the electrolyte. The main solvent may be water in many applications, but other types of polar solvents may be used in specialized applications. The specific types of electrolyte used are based on the contaminants to be removed. For example, in the case of removing salt (Na+), an electrolyte with divalent cations (e.g., Ca++, Mg++) may be used to displace the salt and improve the quality of the soil. With many heavy metals, lowering the pH with an acidic electrolyte and/or the addition of a chelating agent (e.g., EDTA) is effective. With organic contaminants, cationic surfactants are commonly used. The most effective electrolyte recipe depends on the types of contaminants and the soil characteristics. The impact of different soil types, contaminants and electrolytes is derived using small scale tests and the in situ electrokinetic remediation (EKR) literature.

The electrolyte may cause the contaminants to move through the soil by means of ion displacement, diffusion, electromigration, electro-osmosis and hydraulic flow. In some cases, the electrolyte may react chemically with contaminants and in so doing, may make the contaminants more mobile or may partially or completely detoxify them.

The process is designed to consistently produce decontaminated soil with residual contaminant levels below desired or regulated concentrations. Once the soil and contaminant characteristics have been identified and an electrolyte composition has been selected, the contaminant removal rate may be forecast for different operating regimes. The contaminant removal rate is partly a function of the dissociation/reaction equilibrium between the contaminants, the chemicals in the electrolyte and the rate at which equilibrium is reached. The contaminant removal rate is also a function of the volume of electrolyte passing through the soil. FIG. 9 shows an example of the dissociation equilibrium for different levels of salt (Na+) contamination and different electrolyte mixtures. In this case, the dissociation rate is relatively quick and equilibrium is reached in the mixing tank before the slurry enters the treatment unit. As a result, a primary reaction in the treatment unit is the flushing of the pore water and replacement of the Na+ ions with Ca++ and Mg++ ions on the surface of the soil particles. With contaminants with a slower dissociation rate and a lower dissociation equilibrium, progressive removal of the contaminants and a slower throughput rate may be required.

Another factor determining the amount of contaminant removal is the volume of electrolyte passing through the soil. The more electrolyte that is passed through the soil, the lower will be the residual contaminant concentration; however, the total mass of contaminant removed with each succeeding flush of electrolyte decreases exponentially such that a practical maximum contaminant removal limit is achieved.

The volume of electrolyte passing through the soil depends on the electroosmotic and hydraulic flow rates. The electroosmotic flow rate varies with the characteristics of the soil. The basic electroosmotic flow rate equation is:

$$\begin{matrix}Electroosmotic Water Flow & \\ \frac{{q}_{EO}}{A} = {Ek}_{e} & Equation 1\end{matrix}$$

Where
q_{EO} is the volumetric electroosmotic water flowrate [m³/s]
kₑ is the electroosmotic permeability of the slurry [m² s⁻¹V⁻¹]
A is the cross-sectional area of the electrodes [m²]
E is the voltage gradient through the slurry [V/m]

A key factor in this equation is the electroosmotic permeability coefficient. The theoretical equation for the electroosmotic permeability coefficient is:

$$\begin{matrix}Electroosmotic Permeability & \\ {k}_{i} = \frac{{ζ}_{s} {n}_{s} {ε}_{0} {ε}_{w}}{{μ}_{w}} & Equation 2\end{matrix}$$

Where
kₑ is the electroosmotic permeability of the slurry [m2 s−1 V−1]
ζₛ is the zeta potential of the solid particles [V]
nₛ is the porosity of the slurry [dimensionless]
ξ₀ is the vacuum permittivity [C V−1 m−1]
ξ_{w} is the relative permittivity of the water [dimensionless]
μ_{w} is the viscosity of the pore water [kg m−1 s−1]

The electroosmotic permeability coefficient however is best derived empirically. FIG. 10 shows empirically-derived electroosmotic permeability coefficients for different porosities with a kaolinite-dominated soil. The coefficient varies with the porosity of the soil. At the start of a new project, soil electroosmotic permeability coefficients for different porosities may be derived empirically using small-scale tests.

The flow of electrolyte may be driven by hydraulic pressure. The forecast hydraulic flow rate is derived using Darcy's equation

$$\begin{matrix}Hydraulic Water Flow & \\ \frac{q}{A} = ( \frac{( {u}_{anode} - {u}_{cathode} ) {k}_{h}}{{ρ}_{w} g {h}_{s}} ) & Equation 3\end{matrix}$$

Where
qₕ is the volumetric flow rate due to hydraulic pressure [m3/s]
A is the cross-sectional area of the electrodes [m2]
u_{anode} is the pressure applied to the electrolyte at the anode [kPa]
u_{cathode} is the residual pore pressure at the cathode [kPa]
kₕ is the hydraulic conductivity of the slurry [m/s]
ρ_{w} is the density of water [kg/m3]
g is the acceleration due to gravity [N/kg]
hₛ is the height of the slurry chamber [m]

The hydraulic conductivity coefficient is a key factor in Darcy's equation. At the start of a new project, hydraulic conductivity coefficients for different porosities for a given soil type may be derived empirically using small-scale tests or may be derived from the results of particle size analyses. FIG. 11 shows representative hydraulic conductivity coefficients for different porosities in a kaolinite-dominated soil.

These results may be used to calculate the amount of electrolyte that is required to decontaminate a given volume of contaminated soil to a target residual concentration. The desired throughput rate of a single treatment unit may also be estimated based on a specific set of operating parameters; more specifically, 1) the applied voltage and the electroosmotic flow rate, and 2) the applied hydraulic pressure and the hydraulic flow rate. Combining the electrolyte flow rate with the required volume of electrolyte to be passed through the contaminated soil, the soil throughput rate and the residual contaminant concentration in the soil after treatment may be calculated.

Each set of operating parameters and electrolyte compositions determine the required amount of energy consumed, the volume of spent electrolyte and the soil throughput rate. By analyzing the decontamination performance of different combinations of operating parameters and electrolyte compositions, an optimum operating schedule for a specific application may be determined. These calculations may also be used for a given project to determine the number of treatment units to be deployed to decontaminate the required volume of soil in a specified period of time.

Electrokinetic decontamination is achieved by a combination of electromigration and electroosmosis. These processes occur when a contaminated soil is saturated with a reactive electrolyte. The rate at which these processes occur is a function of multiple variables including:
a. The strength and pattern of the electric field,
b. The zeta potential of the soil,
c. The porosity of the soil,
d. The physical and chemical characteristics of the contaminant(s) to be removed, and
e. The physical and chemical characteristics of the electrolyte being passed through the soil.

As the electrolyte moves through the soil, contaminants may be desorbed and ions in the electrolyte may replace the desorbed ions. In other cases, the electrolyte may chemically react with the contaminants to make them more mobile within the electrolyte and may cause the toxicity of the contaminants to be reduced. In all cases, the movement of the electrolyte through the soil is required. The role of electroosmosis is to promote the movement of electrolyte through the contaminated soil.

Electromigration behaves differently than electroosmosis. When contaminants are dissolved as charged ions in the electrolyte, they are drawn through the soil pores by electromigration. The electric field that is formed between the cathodes and anodes causes charged ions to move through the electrolyte toward the oppositely charged electrode. Electroosmosis is complementary to electromigration. Their combined effect is that the movement of contaminant ions may be accelerated increasing the efficiency of the decontamination process. The electromigration rate may be calculated using the following formula:

$$\begin{matrix}Electromigration Rate & \\ \frac{{q}_{m , i}}{A} = \frac{{D}_{i} {z}_{i}^{2} {C}_{i}}{{\sum }_{k} {D}_{k} {z}_{k}^{2} {C}_{k}} \cdot \frac{I}{{z}_{i} F} & Equation 4\end{matrix}$$

Where
q_{m,i} is the molar flow rate of ion, i, due to electromigration [mol/s]
A is the cross-sectional area of the electrodes [m2]
Dᵢ is the diffusivity of ion, i [m2/s]
zᵢ is the unit charge of ion, i [dimensionless]
Cᵢ is the concentration of ion, i [mol/m3]
l is the current density through the slurry [A/m2]
F is Faraday's constant [C/mol]
ΣₖDₖzₖ²Cₖ is the sum of the product of (diffusivity, unit charge squared and concentration) for all ions in the pore water.

FIG. 12 shows representative electromigration rates for different ions in different electric field strengths. Electromigration may account for over 20% of the contaminant removal under some circumstances.

Preferably, the decontamination process may be configured to be monitored continuously by in situ sensors. These sensors may record changes in the soil and electrolyte properties as they pass through the decontamination and dewatering chambers. The applied pressure and power schedule may be adjusted continuously based on the feedback from said in situ sensors and the desired nature of the decontaminated soil that is being produced.

A central control system may be present that automatically regulates the applied pressure, the applied power and the rate at which decontaminated soil is released from the process. The control system may be configured to ensure that the residual contaminants in the decontaminated soil are below a prescribed concentration and that the residual electrolyte content of the decontaminated soil is below a prescribed level.

The residence time of the soil in the decontamination and dewatering chamber processes may partly determine the proportion of the contaminant(s) mass that is removed. In general, the longer the residence time, the greater is the proportion of the contaminant(s) mass that is removed. However, a shorter residence time may be possible to achieve the same level of decontamination if the applied power, the electrolyte composition and/or the amount of hydraulic pressure are changed. Accordingly, the residence time may be coordinated with these other control variables by the control system.

The velocity of the slurry in the treatment unit and the volume of the unit determine the throughput. As the width of a treatment unit is increased, the volume increases and so does the throughput all other things being the same. As the distance between the electrodes is decreased, the distance the electrolyte needs to flow to remove contaminants from the soil and the flow rate of the slurry through the treatment unit can be increased all other things being the same. The throughput may also be increased by increasing the porosity of the slurry, by increasing the applied power, by increasing the hydraulic pressure and/or by increasing the strength of the electrolyte. Balancing the porosity of the slurry, the level of applied power and hydraulic pressure and the composition and concentration of the electrolyte may optimize the costs of the decontamination process.

A key determinant of the effectiveness of electrokinetics is the pattern and strength of the electric field. The electric field strength is proportional to the applied voltage. By changing the applied voltage, the rate of the electrolyte passing through the soil may be adjusted. The optimal electric field strength may change as the electrolyte chemistry and porosity of the slurry change. The electric field pattern is dependent on the shape, composition and surface area of the electrodes and their separation distance. The system may be designed and operated to optimize energy consumption and contaminant removal efficiency.

A key operating consideration may be minimizing the volume of spent electrolyte that needs to be disposed. The volume of spent electrolyte may be reduced by using a countercurrent flow system (FIG. 6). The preferred countercurrent system may vary from one application to another. The volume of spent electrolyte requiring disposal may be further reduced by refurbishing spent electrolyte on site (FIG. 7). In this case, only the concentrated contaminant solution may need to be disposed off site and the refurbished electrolyte may be reused in the decontamination process.

For the purposes of this description and the claims, the term “soil” is generic. “Soil” means one or more types of inorganic or organic material that may be contaminated with inorganic and/or organic contaminants which may be difficult to remove without the teachings herein. These media include contaminated soils, sludges, slurries drilling muds and dredging spoils.

Immaterial modifications may be made to the embodiments described here without departing from what is covered by the claims. For example, the methods and systems disclosed herein apply to different types of soil and to different types of contaminants.

In the claims, the word “comprising” is used in its inclusive sense and does not exclude other elements being present. The indefinite articles “a” and “an” before a claim feature do not exclude more than one of the features being present. Each one of the individual features described here may be used in one or more embodiments and is not, by virtue only of being described here, to be construed as essential to all embodiments as defined by the claims.

1. A method of facilitating decontamination of soil through application of an electrical current, the method comprising:
a. mixing an electrolyte into the soil to form a slurry;
b. passing the slurry through a flow path in a contiguous series of a decontamination chamber and a dewatering chamber, the flow path extending between an inlet and an outlet, each of the decontamination chamber and the dewatering chamber including at least two electrodes, the flow path passing between the at least two electrodes in the decontamination chamber and the at least two electrodes in the dewatering chamber and the at least two electrodes in the decontamination and dewatering chambers configured to induce movement of the electrolyte within the slurry.

2. The method of claim 1 further comprising the step of screening the soil by removing material above a certain size prior to passing the slurry through the flow path.

3. The method of claim 1 in which the at least two electrodes in the decontamination chamber comprise at least one cathode and at least one anode having a DC current passing between them to induce electrolyte movement within the flow path from the at least one anode to the at least one cathode.

4. The method of claim 1 in which the at least two electrodes in the dewatering chamber comprise at least one cathode and at least one anode having a DC current passing between them to induce electrolyte movement within the flow path from the at least one anode to the at least one cathode.

5. The method of claim 3 in which a vertical hydraulic pressure gradient above atmospheric pressure is maintained between the at least two electrodes in the decontamination chamber comprising at least one cathode and at least one anode to induce electrolyte movement within the flow path from the at least one anode to the at least one cathode.

6. The method of claim 1 in which a horizontal hydraulic pressure gradient from the inlet to the outlet above atmospheric pressure is maintained within the decontamination chamber and the dewatering chamber to induce movement of the slurry through the flow path from the inlet to the outlet.

7. The method of claim 3 in which electrolyte is introduced into the decontamination chamber adjacent to the at least one anode and the electrolyte exits the decontamination chamber adjacent to the at least one cathode.

8. The method of claim 3 in which pressure on the electrolyte that is introduced at the at least one anode is maintained at above atmospheric pressure to induce movement of the electrolyte through the flow path to the cathodes of the decontamination and dewatering chambers.

9. The method of claim 4 in which the electrolyte exits the dewatering chamber adjacent to the at least one cathode.

10. The method of claim 1 in which the at least two electrodes in the decontamination chamber further comprise a plurality of cathodes and a plurality of corresponding anodes together forming corresponding cathode and anode pairs having a DC current passing between them to induce movement of one or both of electrolyte and dissolved ions within the flow path from the plurality of anodes to the plurality of cathodes.

11. The method of claim 10 in which each of the corresponding cathode and anode pairs in the decontamination chamber are each separated by at least a minimum distance and the at least two electrodes in the dewatering chamber are separated by a second distance and the minimum distance is larger than the second distance.

12. The method of claim 1 further comprising adjusting an applied power across one or more of the at least two electrodes in each of the decontamination chamber and the dewatering chamber while the slurry passes through the flow path.

13. The method of claim 6 further comprising controlling a flow rate of the slurry through the flow path by means of an adjustable valve on the outlet.

14. The method of claim 7 in which the electrolyte collected at the cathodes is recycled using a countercurrent flow pattern after exiting the decontamination chamber and the dewatering chamber.

15. The method of claim 7 in which the electrolyte collected at the cathodes is sent for refurbishment after exiting the decontamination chamber and the dewatering chamber.

16. The method of claim 15 in which the electrolyte sent for refurbishing that exits the decontamination chamber and the dewatering chamber is refurbished, and the refurbished electrolyte is reused in the treatment process.

17. The method of claim 1 in which one or more control systems is used to balance a flow of the slurry, a flow of the electrolyte and the applied power across one or more of the at least two electrodes in each of the decontamination chamber and the dewatering chamber.

18. A decontamination system for facilitating the decontamination of soil through application of an electrical current: the system comprising:
one or a plurality of treatment units connected in parallel, each treatment unit having connected decontamination and dewatering chambers, each treatment unit having a flow path between an inlet and an outlet, each decontamination chamber and each dewatering chamber including at least one anode and cathode pair within the flow path.

19. (canceled)

20. The decontamination system of claim 18 in which the system includes a pressure source to maintain horizontal hydraulic pressure above atmospheric pressure to the slurry within the decontamination chamber and dewatering chamber to induce movement through the flow path to the outlet and to maintain horizontal hydraulic pressure above atmospheric pressure to the electrolyte introduced adjacent to the anodes in the decontamination chamber.

21.-25. (canceled)

26. A treatment unit for facilitating the decontamination of soil through application of an electrical current, the treatment unit comprising:
an inlet and an outlet;
a decontamination chamber and a dewatering chamber adjacent to each other defining a flow path between the inlet and the outlet; and
at least one anode and cathode pair within each of the decontamination chamber and the dewatering chamber, the flow path passing between each of the at least one anode and cathode pairs.

27.-37. (canceled)
